(19) United States
(12) Patent Application Publication
(10) Pub. No.: US 2010/0145539 A1
(43) Pub. Date: Jun. 10, 2010

(54) Energy Management System for a Motor Vehicle

(76) Inventor: Matthias Schmidt, Stuttgart (DE)

Correspondence Address: KENYON & KENYON LLP, ONE BROADWAY, NEW YORK, NY, 10004, US

(21) Appl. No.: 11/992,276

(22) PCT Filed: Sep. 11, 2006
(86) PCT No.: PCT/EP2006/066225

§ 371 Date: Apr. 21, 2009

(30) Foreign Application Priority Data
Sep. 20, 2005 (DE) 102005044829.1

(51) Int. Cl. B60L 1/00

(52) U.S. Cl. 700/295; 307/10.1

(57) ABSTRACT

In an energy management system for a motor vehicle, the system has an energy manager that contains a computing unit. Connected to the energy manager are a memory device and a plurality of electrical system components that include energy-producing devices, energy storage devices, and consumers of energy. Various possible operating states are assigned to each of the energy producers and energy storage devices, and these states are represented as the summation of an energy producer and of zero, one, or a plurality of what are known as virtual energy consumers.

### FIELD OF THE INVENTION

The present invention relates to an energy management system for a motor vehicle.

### BACKGROUND OF THE INVENTION

Energy management systems known up to now are matched to a particular vehicle and its specific group of consumers. They cannot be straightforwardly transferred to other vehicles. Thus, cost advantages that would be present if such transfer to other vehicles were possible cannot be taken advantage of.

German Patent document DE 197 45 849 A1 discusses a device which is for energy distribution in a motor vehicle that has a generator, driven by an internal combustion engine, that supplies an vehicle electrical system with electrical power. The energy distribution is realized using a control device that operates as a vehicle electrical system manager. Necessary information is supplied to the control unit, from which this unit executes a control strategy for controlling the components of the vehicle electrical system and of the internal combustion engine. The energy distribution between the vehicle electrical system and the internal combustion engine takes place according to specifiable demands, taking into account the condition that the target voltage of the vehicle electrical system should be within prespecifiable limits.

German Patent document DE 198 29 150 A1 discusses a method and a device which are for energy distribution in a motor vehicle that has at least one battery and at least one generator. Here, a hierarchical control structure is used. This structure is made up of a higher-order component and components subordinated thereto for controlling the at least one generator and the at least one battery. Here, interfaces having specified communication relations are provided between the higher-order component and the subordinate components. The communication relations are tasks that must be executed by the components charged with them, requirements that must be met by the component concerned, and queries that must be responded to by the queried component. Between the subordinate component of the at least one generator and the higher-order component, the power or voltage that is to be set is communicated as a task and the potential power production of the generator is communicated as a query. In addition, the electrical power potential of the battery is communicated as a query between the at least one battery, as subordinate component, and the higher-order component.

German Patent document DE 102 32 539 A1 discusses a method and a device which are for managing electrical energy in an electrical system of a motor vehicle. This vehicle electrical system has a plurality of electrical consumers that are supplied with electrical energy by a generator and a battery. In a first phase, after being switched on the consumers demand a peak power, and in a second phase after being switched on they demand a nominal power. In addition, a control device is provided for executing an energy and consumer management system. In order to avoid voltage drops when consumers are connected, and in order to improve vehicle safety, it is proposed that after a switch-on request the peak power and nominal power available in the vehicle electrical system be determined, and that the time at which the consumer is switched on be temporally delayed, and that measures be introduced in order to increase the supply power and/or to reduce consumption, if sufficient peak or nominal power is not available. The new consumer is not connected until sufficient peak and nominal power can be provided.

### SUMMARY OF THE INVENTION

In contrast, an energy management system having the features described herein has the advantage that it is possible to carry out a very precise, differentiated control of the load flow. Differing from known energy management systems, in which a separation is made between energy producers, energy storage devices, and energy consumers, in the new energy management system this division is no longer present. This makes it possible for example to determine precisely for which classes of energy consumers how much energy may, for example, be taken from a battery, and for which classes of consumers this may not be done.

Other features described herein advantageously enable the claimed energy management system to be put into use so as to be capable of expansion and capable of being used with different vehicle product lines. A new electrical system component need merely be assigned a priority index number and one or more classes; at any particular time, each consumer can belong to only one class. If the associated data are then stored in the storage device, these data can then be used in addition to the previously existing data for energy management.

This energy management can be carried out by the energy manager directly, using the stored data processed by the computing unit. For example, on the basis of the evaluation of the stored data carried out by the computing unit, the energy manager recognizes that the existing energy is sufficient only for the existing safety-relevant consumers. Consequently, the manager carries out a controlling according to which the safety-relevant consumers are able to take current from the battery, but comfort-related consumers are not.

Alternatively, the energy management can also communicate information concerning the existing energy to the control units allocated to the vehicle electrical system components, which can then control the respectively allocated electrical system component. In this specific embodiment, the control intelligence is located in a decentralized fashion at the respective electrical system components.

The class assignment of an electrical system component may be capable of being changed during operation. For example, a heating device allocated to class 5 and switched off by the energy manager could be changed to class 4 after a certain period of time in order to signal that the switching off of the heating device is now perceptible and that it is necessary to immediately switch the heating device on again. In addition, an energy producer can also belong to different classes. In class 0, it is emitting its maximum possible power. However, it can also be assigned to a higher class as a virtual consumer, can draw power, and can thus lower its output power. In addition, a storage device can also belong to various classes. In class 0, it is emitting the maximum possible output power. In a higher class, as a virtual consumer it can draw power and can thus reduce its output power, or can even draw power overall.

Given the presence of a consumer having a plurality of power stages, each power stage may be regarded as an independent consumer to which there is assigned a separate priority index number and one or more classes. The power of the consumer corresponds to the power required in addition to the previous stage. This improves the capacity for integrating arbitrary additional consumers into the energy management system without modifying its core.

Consumers that do not have stages may be subdivided into the smallest stages that it makes sense to control, each stage being assigned a separate priority index number and one or more classes. This improves the capacity for the integration of additional consumers without stages into the energy management system without modifying its core.

All the vehicle electrical system components named above can be assigned to various classes, i.e., they can change from one class to another, but at a given point in time a vehicle electrical system component is assigned to only one class.

Additional advantageous characteristics of the exemplary embodiments and/or exemplary methods of the present invention result from the explanation of examples thereof on the basis of the drawings.

### BRIEF DESCRIPTION OF THE DRAWINGS

FIG. 1 shows a schematic diagram of a first specific embodiment of an energy management system according to the present invention.

FIG. 2 shows a drawing explaining the structure of memory device 3 of FIG. 1.

FIG. 3 shows a drawing illustrating the allocation of vehicle electrical system components to the classes and priority index numbers.

FIG. 4 shows a schematic diagram of a second specific embodiment of an energy management system according to the present invention.

### DETAILED DESCRIPTION

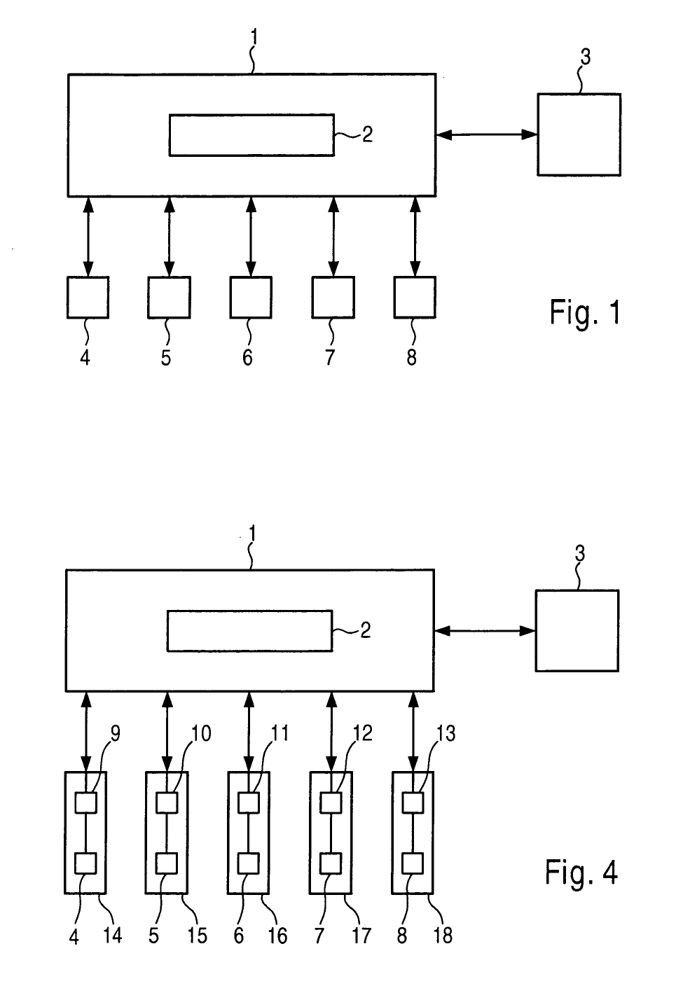

FIG. 1 shows a schematic diagram of a first specific embodiment of an energy management system according to the present invention. According to this specific embodiment, the energy management system has an energy manager 1 that contains a computing unit 2. Energy manager 1 is connected to a memory device 3 to which data are written and from which data are read. In addition, energy manager 1 is connected to an energy producer 4, an energy storage device 5, and energy consumers 6, 7, and 8. Energy producer 4 can be a generator, and energy storage device 5 can be a battery. Energy consumers 6, 7, 8 are real energy consumers. For example, energy consumer 6 is a heating device of the vehicle, energy consumer 7 is a brake control system (ABS) of the vehicle, and energy consumer 8 is the vehicle radio. All the above-named energy producers, energy storage devices, and energy consumers are designated vehicle electrical system components.

These vehicle electrical system components are divided into classes. The following table shows an example of such division into classes:

TABLE 1

| | |
|---|---|
| Class 0 | Producers and storage devices (all with maximum output |
| | power) |
| Class 1 | Basic load (all consumers without information-related |
| | signal connection) |
| Class 2 | Non-influenceable consumers (safety-related and |
| | legally relevant consumers) |
| Class 3 | Consumers that are not safety-related, but are clearly |
| | perceptible in case of degradation |
| Class 4 | As class 3, but degradation barely perceptible |
| Class 5 | As class 3, but degradation not perceptible |
| Class 6 | P_{MAX} (boost) |
| Class 7 | P_{MAX} (boost, but without subsequent savings potential) |

Consequently, all energy producers and energy storage devices are assigned to class 0 with their maximum possible output power, e.g. generator 4 and battery 5.

Class 1 includes all energy consumers that do not have information-related signal connections. These include for example headlights that are not controlled via a data bus. Class 2 includes all consumers that are not capable of being influenced. This refers to safety-relevant and legally relevant consumers, such as a brake control system, headlights, a secondary air pump, or an electrical heating device for a catalytic converter. Class 3 includes all non-safety-relevant consumers whose switching off in case of degradation is easily perceptible. These include for example the vehicle radio and the window up/down switches. Class 4 includes all non-safety-relevant consumers whose switching off in the case of degradation is perceptible only within a limited scope. These include for example seat heating devices. Class 5 includes all non-safety-relevant consumers whose switching off in the case of degradation is not perceptible. These include for example a rear window heating unit. Class 6 includes all non-safety-relevant consumers having maximum consumption at all times. These include for example the passenger compartment heating system. Consumers of classes 2-7 can change their class assignments during operation. Class 7 includes all non-safety-relevant consumers having maximum power consumption at all times but whose activation is not connected with a subsequent savings potential. These include for example the rear window heating device when the external temperature is high.

In addition, priority index numbers are defined that provide information about the importance of a vehicle electrical system component for the energy distribution. For example, priority index number PK=1 is assigned to generator 4, priority index number PK=2 is assigned to battery 5, priority index number PK=5 is assigned to the basic load and the secondary air pump, priority index number PK=6 is assigned to the brake control system, priority index number PK=7 is assigned to the headlights, and priority index numbers 14, 15 and 16 are assigned to three different power stages of a consumer, for example a heating device.

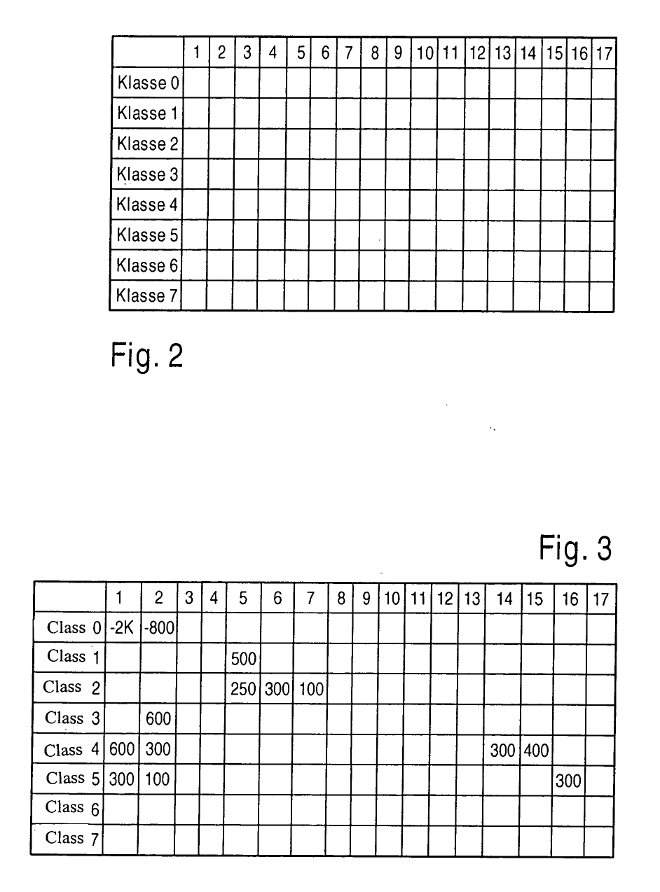

FIG. 2 shows a drawing for the explanation of the structure of memory device 3 of FIG. 1. As can be seen in FIG. 3, the memory locations of memory device 3 are organized in the form of a matrix. Here, the total of eight different classes are indicated on one axis, and for example a total of 17 priority index numbers are indicated on the other axis.

FIG. 3 shows a drawing illustrating the allocation of vehicle electrical system components to the classes and priority index numbers.

According to FIG. 3, priority index number PK=1 is fixedly allocated to generator 4, which is a power producer. Each energy producer has various operating states. In one of these operating states, it emits its maximum possible power, which in the case of generator 4 is for example 2000 W. This operating state is assigned to class 0. The power emitted by the generator in this operating mode is shown as a negative balance in FIG. 4; i.e., it is prefixed with a minus sign.

Each power producer can reduce its output power by drawing power using one or more virtual consumers, as they are called, in higher classes. In the case of generator 4, this reduction of the output power is present for example when there is a reduction in no-load rotational speed and a reduction of moment. Other classes, e.g. classes 4 and 5, are assigned to these virtual consumers; here the generator consumes 600 W of power according to class 4 and consumes 300 W of power according to class 5. This is illustrated in the following table, in which the effective output power of the generator is indicated in the last column.

TABLE 2
Producer:

| | | | | Effective |
|---|---|---|---|---|
| Operating mode | PK | Class | Power | output power |
| Full load | 1 | 0 | −2000 W | −2000 W |
| Full load with reduced | 1 | 4 | 600 W | −1400 W |
| rotational speed | | | | |
| Partial load for moment | 1 | 5 | 300 W | −1100 W |
| reduction | | | | |

The generator represents an interface to a higher-order control system. For example, the generator is given a command for the above-indicated moment reduction by this higher-order control system.

As the above shows, an energy producer is assigned various possible operating states or operating modes, these operating states being represented by a summation of a real energy producer and zero, one, or a plurality of virtual energy consumers. The virtual energy consumers are cleared or blocked by the energy manager dependent on the existing quantity of energy and the momentary energy requirement. The operating state to be selected by the generator can be derived directly from these clearances.

In addition, according to FIG. 3 battery 5, which is an energy storage device, is assigned priority index number PK=2. Each energy storage device also has various operating states. In one of these operating states, it emits its maximum possible power, which in the case of battery 5 is 800 W. This operating state is assigned to class 0. The energy emitted by the battery in this operating mode is given a negative balance in FIG. 4; i.e., it is prefixed with a minus sign.

Each energy storage device can reduce its output power, or can consume power, by drawing power via one or more virtual consumers in higher classes. These virtual consumers are assigned to other classes, e.g. classes 3, 4, and 5. Here, as can be seen in FIG. 3, in class 3 the energy storage device consumes a power of 600 W, in class 4 it consumes a power of 300 W, and in class 5 it consumes a power of 100 W. This is illustrated in the following table, in which the last column indicates the effective power of the energy storage device.

TABLE 3
Storage device:

| | | | | Effective |
|---|---|---|---|---|
| Operating mode | PK | Class | Power | power |
| Producer stage 2 (max. output | 2 | 0 | −800 W | −800 W |
| power) | | | | |
| Producer stage 1 (reduced output | 2 | 3 | 600 W | −200 W |
| power) | | | | |
| Consumer stage 1 (reduced power | 2 | 4 | 300 W | +100 W |
| consumption) | | | | |
| Consumer stage 2 (normal power | 2 | 5 | 100 W | +200 W |
| consumption) | | | | |

As the above shows, an energy storage device is assigned various possible operating states or operating modes, these operating states being represented by a summation of a real energy producer and zero, one, or a plurality of virtual energy consumers. The virtual consumers are cleared or blocked by the energy manager dependent on the existing quantity of energy and the momentary energy requirement.

Priority index numbers 3 and 4 are reserved for additional energy storage devices that are not provided in the present exemplary embodiment.

In addition, in FIG. 3 the basic load is assigned priority index number PK=5 and class 1, in which a power consumption of 500 W is given. In addition, the same priority index number PK=5 is assigned to another consumer, for example a secondary air pump of the vehicle. This consumer is assigned to class 2 and has a power consumption of 250 W.

According to FIG. 3, another consumer is assigned priority index number PK=6. This additional consumer has only one operating state, to which class 2 is assigned. This additional consumer has a power consumption of 300 W. This additional consumer is for example a brake control system.

In addition, according to FIG. 3 still another consumer is provided to which priority index number PK=7 is assigned. This additional consumer also has only one operating state, to which class 2 is assigned. This additional consumer has a power consumption of 100 W. This can be a headlight.

Finally, according to FIG. 3 a consumer is provided that is capable of being operated in three power stages. For example, this consumer can be a heating element of the vehicle. Each of the power stages of this consumer is regarded as a separate, independent consumer. Power stage 1 is assigned priority index number PK=14, power stage 2 is assigned priority index number PK=15, and power stage 3 is assigned priority index number PK=16. In addition, power stages 1 and 2 are each assigned to class 4, and power stage 3 is assigned to class 5. In class 4, the consumer having priority index number PK=14 consumes 300 W of power. In class 4, the consumer having priority index number PK=15 has a power consumption of 400 W. The consumer having priority index number PK=16 has in class 5 a power consumption of 300 W. This is illustrated in the following table, in whose last column the overall power is indicated.

TABLE 4
Consumer:

| Operating | | | | Overall |
|---|---|---|---|---|
| mode | PK | Class | Power | power |
| Stage 1 | 14 | 4 | 300 W | 300 W |
| Stage 2 | 15 | 4 | 400 W | 700 W |
| Stage 3 | 16 | 5 | 300 W | 1000 W |

During operation, each of the consumers named above can dynamically change its class. If, for example, a heating consumer assigned to class 5 is switched off by the energy management system, after a certain period of time it can change to class 4. This change indicates that the switching off of the heating consumer that was carried out is now perceptible.

Consequently, according to the exemplary embodiments and/or exemplary methods of the present invention each consumer is unambiguously assigned a priority index number that does not change. Conversely, however, one priority index number can be assigned to a plurality of consumers. At any given time, each consumer can belong to only one class. Consumers in the sense of the exemplary embodiments and/or exemplary methods of the present invention are, in the case of one-stage consumers, the consumer itself, while in the case of multi-stage consumers the consumer is always only one switching stage of the consumer. If consumers having the same priority index number are present in different classes, they can always be controlled independently of one another. However, if two consumers have the same priority index number and the same class, they can be switched on and off only together.

Energy manager 1 carries out the energy management using the data that are stored in memory device 3 and illustrated in FIG. 3. These stored data, which indicate power consumption or power output of the vehicle electrical system components, are read out from memory device 3 by computing unit 2 of energy manager 1, and are subjected to a computing process. During this computing process, a point of equilibrium is determined by adding up the indicated power values, line by line from left to right, until the determined sum is greater than a threshold value, which is for example 0. If the last summand is then subtracted again, the greatest possible value less than 0 is obtained. From this, information can now be derived concerning a resulting class and a resulting priority index number, containing information as to which consumers are permitted to consume what quantity of energy, and which are not.

According to the first specific embodiment, shown in FIG. 1, this information is used by energy manager 1 to directly control the individual consumers, for example to switch them off, in order to ensure that the total amount of energy consumed by all the consumers remains smaller than the amount of energy that is available.

According to a second specific embodiment, the cited information is communicated only to all vehicle electrical system components by the energy manager. Each of these components is provided with a separate control unit that uses the communicated information to set the energy consumed by the electrical system component in accordance with the communicated information.

In addition, a combination of the two specific embodiments described above is also possible.

FIG. 4 shows a schematic diagram of this second specific embodiment of an energy management system according to the present invention. As in the specific embodiment shown in FIG. 1, this specific embodiment has an energy manager 1 that includes a computing unit 2. Energy manager 1 is connected to memory device 3 in order to read data therefrom and to write data thereto.

The information outputted by energy manager 1 concerning the resulting class and the resulting priority index number is communicated to all vehicle electrical system components. Vehicle electrical system component 14 is a generator unit that has a generator control unit 9 and a generator 4. Generator control unit 9 uses the information outputted by energy manager 1 in order to set the energy outputted by generator 4 in accordance with the communicated information. For example, generator control unit 9 can see to it that the output power is reduced. This can achieve the effect of reducing the torque of the generator, thus making available more torque from the internal combustion engine in order to accelerate the vehicle.

Vehicle electrical system component 15 is an energy storage unit that has a storage control unit 10 and an energy storage device 5. Storage control unit 10 uses the information outputted by energy manager 1 to set the energy consumed by energy storage device 5 in accordance with the communicated information. For example, storage control unit 10 can see to it that no charging of the energy storage device takes place, in order to ensure that the total energy consumed by all consumers remains smaller than the available amount of energy.

Alternatively, vehicle electrical system component 15 can also be a battery unit that has a battery state recognition device 10 and a battery 5. The battery state recognition device informs energy manager 1 of the state of the battery. Energy manager 1 controls the battery power indirectly, via the vehicle electrical system voltage. This can take place by specifying a target voltage to the generator using a suitable model.

Vehicle electrical system component 16 is a consumer unit that has a consumer control unit 11 and a consumer 6. Consumer control unit 11 uses the information outputted by energy manager 1 to set the energy consumed by consumer 6 in accordance with the communicated information. For example, consumer control unit 11 can see to it that consumer 6 is switched off, in order to ensure that the total energy consumed by all consumers remains smaller than the available amount of energy.

Vehicle electrical system component 17 is a consumer unit that has a consumer control unit 12 and a consumer 7. The consumer control unit uses the information outputted by energy manager 1 to set the energy consumed by consumer 7 in accordance with the communicated information. For example, consumer control unit 12 can see to it that consumer 7 is switched off, in order to ensure that the total energy consumed by all consumers remains smaller than the available amount of energy.

Vehicle electrical system component 18 is a consumer unit that has a consumer control unit 13 and a consumer 8. Consumer control unit 13 uses the information outputted by energy manager 1 to set the energy consumed by consumer 8 in accordance with the communicated information. For example, consumer control unit 13 can see to it that consumer 8 is switched off in order to ensure that the total energy consumed by all consumers remains smaller than the available amount of energy.

In addition, the dynamic behavior of the consumers is taken into account using what are known as envelope curves. For this purpose, each consumer having a significant switch-on characteristic provides a parameter set (H₁, t₁; H₂, t₂; . . . ) to energy manager 1, describing its time characteristic.

The power of the consumer is then calculated as follows:

P(t)=H(t)·P_{Nominal}

Using a standardized description of this sort, all consumers can be covered to a good approximation. Using the envelope curves, a look-ahead functionality can be achieved. For example, in a time interval of five seconds the energy balance can be calculated, and, dependent on the result of the calculation, additional switching commands can be outputted or suppressed. In addition, the switch-on times of loads having a high switch-on pulse can be temporally equalized.

Summarizing, it can be stated that in the exemplary embodiments and/or exemplary methods of the present invention no strict division is made between producers, storage devices, and consumers. The purpose for which a battery that is present may be discharged can be defined precisely. The concept of the exemplary embodiments and/or exemplary methods of the present invention can easily be incorporated into a higher-order control system. Through the management system according to the second specific embodiment of the present invention, the bus present in the vehicle is only lightly loaded, because only information about a resulting class and a resulting priority index number is communicated. A message is sent to the energy manager by the consumers only in the case of a change of status or a change of class. Further advantages of the exemplary embodiments and/or exemplary methods of the present invention include a high degree of precision of the consumer peak load reduction, scalability, and easy adaptability to customer wishes.

In addition, the manner of operation of an energy management system according to the present invention is easily understood and applied. New consumers can easily be incorporated into the design, because a standardized interface exists. New components can be recognized automatically and can be integrated into an existing system in accordance with a plug-and-play functionality. In the exemplary embodiments and/or exemplary methods of the present invention, a dynamic prioritization takes place of the vehicle electrical system component power levels, which enables controlling with only minimum perceptibility of the control interventions. According to the second specific embodiment described above, which is based on a decentralized consumer model, the consumer state is not represented in the energy manager, because the intelligence relating to the consumer state is located in the consumer itself, or at least outside the energy manager.

An energy management system according to the present invention can serve as a basis for an energy management concept that is applicable in different models, as well as for a standardized energy management concept that is applicable to products of different manufacturers, because each vehicle electrical system component is described by a standardized parameter set and has a standard interface. This makes possible an adaptation to various vehicles and levels of equipping. In contrast, in known energy management systems it was necessary to take consumer interfaces for multistage consumers into account in the energy manager in a complicated manner. The measure according to which each stage is treated as a separate consumer makes it possible to integrate arbitrary consumers without having to modify the core of the energy management system.

The List of reference characters is as follows:
1 energy manager
2 computing unit
3 memory device
4 energy producer, generator
5 energy storage device, battery
6 first energy consumer
7 second energy consumer
8 third energy consumer
9 generator control unit
10 storage control unit, battery state recognition
11 consumer control unit
12 consumer control unit
13 consumer control unit
14 generator unit
15 energy storage unit
16 consumer unit
17 consumer unit
18 consumer unit

1-10. (canceled)

11. An energy management system for a motor vehicle, comprising:
an energy manager having a computing unit;
a memory device connected to the energy manager; and
a multiplicity of vehicle electrical system components, which include energy producers, energy storage devices, and energy consumers;
wherein the energy producers and the energy storage devices are each assigned different possible operating states, and the operating states are each represented by a summation of a real energy producer and one of zero, one, and a plurality of virtual energy consumers.

12. The energy management system of claim 11, wherein the memory locations of the memory device are organized in a form of a matrix, each of the vehicle electrical system components being assigned a priority index number and at least one class, and wherein there are stored in the memory device, for each vehicle electrical system component and each associated class, data that describe one of an energy output and an energy consumption of a respective vehicle electrical system component for the respective class.

13. The energy management system of claim 12, wherein the energy manager performs the energy management using stored data that are processed by the computing unit.

14. The energy management system of claim 13, wherein the computing unit adds up stored data and compares it to at least one threshold value.

15. The energy management system of claim 13, wherein the energy manager uses the resulting data determined by the computing unit to control the vehicle electrical system components.

16. The energy management system of claim 13, wherein the vehicle electrical system components are each assigned a control unit, the energy manager communicates the resulting data determined by the computing unit to a respective control unit, and the respective control unit uses the resulting data to control a respective vehicle electrical system component.

17. The energy management system of claim 15, wherein the resulting data contain information about a resulting class and a resulting priority index number.

18. The energy management system of claim 12, wherein the assigned class of an vehicle electrical system component is modifiable.

19. The energy management system of claim 11, wherein, in an energy consumer having a plurality of power stages, each power stage is assigned a separate priority index number.

20. The energy management system of claim 11, wherein an energy consumer not having stages is divided into stages, each of which is assigned to a defined power stage, and each stage is assigned a separate priority index number.
